(19) United States
(12) Patent Application Publication
(10) Pub. No.: US 2002/0078714 A1
(43) Pub. Date: Jun. 27, 2002

(54) Method and apparatus for continuously manufacturing optical preform and fiber

(76) Inventors: Lindwood A. Bird, Wilmington, NC (US); James H. Faler, Wilmington, NC (US); Dale R. Powers, Painted Post, NY (US); Bruce W. Reding, Wilmington, NC (US); Manivannan Ravichandran, Wilmington, NC (US)

Correspondence Address: CORNING INCORPORATED, SP-TI-3-1, CORNING, NY, 14831

(21) Appl. No.: 10/017,767

(22) Filed: Dec. 13, 2001

Related U.S. Application Data
(60) Provisional application No. 60/255,480, filed on Dec. 14, 2000.

(51) Int. Cl. C03B 37/018

(52) U.S. Cl. 65/427; 65/422

(57) ABSTRACT

A method an apparatus for continuously producing optical waveguide fiber and preforms. A continuous supply of core cane is provided to a walled deposition chamber upon which glass soot is deposited to form a soot preform. The preform is passed through an aligned drying, consolidation and draw chambers from which an optical fiber may be drawn. In one embodiment, a plurality of burners are positioned at different radial distances from a longitudinal axis of the cane in the deposition chamber. One or more environmental seal(s) are provided to prevent process gasses or contaminants from flowing into or between the chambers.

This application claims the benefit of and priority to U.S. Provisional Patent Application Serial No. 60/255,480 filed Dec.14, 2000.

### FIELD OF THE INVENTION

The present invention relates generally to a method and apparatus for manufacturing of optical preform and optical fiber, and more particularly to a method and apparatus for manufacturing continuous lengths of optical preform and fiber.

### Background of the Invention

Optical waveguide fibers are generally manufactured by drawing a thin strand of fiber from an optical preform made of high-purity glass. One prior art method utilizes a soot preform, formed for example, by a Outside Vapor Deposition (OVD) method where a silica containing soot is deposited upon a rotating substrate, such as an alumina mandrel or core cane. The soot preform is then consolidated in a first furnace to transform the soot preform into a vitrified glass preform. The vitrified preform is then transferred to a draw furnace where an optical fiber is drawn therefrom. In one particular OVD process, the substrate comprises a slender rod-like glass core cane formed in a previous step. The core cane generally includes the doped core portion and may include a thin overclad portion, for example. The doped core portion generally comprises what will become the fiber's core, when drawn.

In a subsequent laydown process, the core cane functions as a mandrel and additional silica-containing soot cladding is deposited on the outside surface until the desired thickness is reached, thus forming the soot preform. The doped cane with deposited cladding is then vitrified in a consolidation furnace, transferred to and heated in a draw furnace, and drawn into optical fiber. Although this process produces excellent quality fiber, it suffers from the drawback that the draw furnace must be repeatedly started and stopped, thus limiting manufacturing output.

Another method of forming a preform is the Vapor Axial Deposition (VAD) method. In this method, an axial length of preform includes a core and clad formed simultaneously while the preform is traversed axially. Strategically located burners provide the soot while the starting member (usually a circular plate) is rotated and axially traversed. Generally, one burner provides the core material and the other provides the cladding. Subsequently, in separate processes, the preform is consolidated and then drawn into an optical fiber having a core and a cladding.

It should be recognized that these preforms are of finite length. Therefore, problematically, only a finite amount of fiber may be manufactured therefrom before a new preform must be placed into the draw tower. Of course, there is a large amount of fiber on the beginning and ending parts of the preform that is unusable because its optical properties are not within desired specifications. Moreover, starting the draw process is, in and of itself, time consuming, as the preform must be loaded, brought to the appropriate temperature, threaded through the various portions of the draw tower and finally onto a fiber winding spool. Furthermore, variations in the properties from one preform to the next may detrimentally effect statistical scatter of the resulting fiber.

U.S. Pat. No. 4,230,472 to Schultz describes a method of forming a substantially continuous optical waveguide. In the method, a continuous amount of starting core 10 is provided, for example, by butt welding short lengths of core 10. Burners 14 apply particulate materials to the axial exterior surface of the core member 10 to form a uniform deposition of cladding about the core as the core is translated along its longitudinal path. The uniform deposition is next heated and consolidated along the longitudinal path by heaters 28 to form a consolidated blank. Further downstream along the longitudinal path, heaters 36 melt the consolidated preform and an optical fiber is drawn therefrom. Means 37, 39 and 40 grip and rotate the preform or soot. Thus, '472 Schultz patent teaches a process desirable for continuously forming an optical fiber. However, the Schultz process is incompatable with formation of high-quality, low attenuation fiber require in today's telecommunication systems because along the process the soot blank and preform are subjected to contaminants. Moreover, the mechanism described for rotation (i.e., the mechanism that grasps the soot or consolidated preform) is likely to cause damage to the soot preform and produce contamination or seeds that may degrade the trailing soot laydown process or provide break sites on the consolidated preform. U.S. Pat. No. 4,407,667. to LaNoane et al. teaches another method of supplying a continuous length of core to a manufacturing process. However, the '667 process suffers from the inability to produce a continuous length of preform and fiber because lengths drawn from segments L₂ are unusable. Moreover, the various stages employed are subject to contamination. Other method of producing continuous preforms/fiber are taught in U.S. Pat. No. 4,388,094and U.S. Pat. No. ,4,552,576.

Double crucible methods such as described in U.S. Pat. No.4,217,123and U.S. Pat. No.4,466,818are capable of producing continuous lengths of optical fiber. In such methods, separate crucibles are provided for containing molten core and cladding glass. Molten glass streams are united at nozzle portions at the bottom of the crucibles to form a continuous optical fiber. The crucibles may be continuously fed to maintain the level of glass in each at a constant predetermined level. Notably controlling of the hydrostatic head in each chamber is very difficult and thereby may result in non-constant core-to-clad diameter ratios along the length of the optical fiber.

Thus, there is a need for a simple and cost-effective method of manufacturing high quality continuous length optical preforms and fiber that minimizes the aforementioned problems.

### SUMMARY OF THE INVENTION

In accordance with the invention, an improved method and apparatus is provided for manufacturing a continuous length of optical fiber preform and optical fiber. In a first embodiment, the method and apparatus in accordance with the invention may be utilized for continuously manufacturing high-quality optical fiber preforms. More particularly, the method of manufacturing optical fiber preform in accordance with the invention comprises the steps of forming a continuous supply of core cane, grasping and imparting rotational motion to the core cane with a feed apparatus, and depositing soot onto the core cane in a deposition chamber to form a soot preform. The step of depositing soot is accomplished by using a plurality of spaced burners that are preferably positioned at radially non-equidistant points from the longitudinal axis of the core cane. Most preferably, the burners are oriented to apply soot in a direction substantially perpendicular to the core can s longitudinal axis.

In accordance with a further embodiment, the invention further comprises a step of consolidating the soot preform in a consolidation chamber longitudinally aligned with the deposition chamber thereby vitrifying the soot preform into a glassy consolidated preform. The method may also include a step of dehydrating the soot preform in a drying chamber longitudinally aligned with the deposition chamber prior to the step of consolidating. The preform formed according to the method is preferably of substantially constant diameter and of substantially continuous length thereby leading to manufacturing efficiencies by continuous operation of the forming process.

In another embodiment, the method comprises a step of cleaning a periphery of the core prior to depositing. The cleaning step preferably comprises passing the core through an apparatus that imparts a wiping and/or chemical cleaning action. This removes any debris or contaminants that may be the source of unwanted seeds at the cane/cladding interface.

An optical fiber preform manufacturing apparatus in accordance with the invention comprises a downfeeder providing a continuous supply of core cane, the downfeeder grasping and imparting movement to the core cane, and a deposition chamber, including at least one burner, in which soot is deposited onto the core cane to form an optical fiber soot preform. The apparatus preferably comprises a drying chamber in which the soot preform is dried, the drying chamber being longitudinally aligned with the deposition chamber. The apparatus may also comprise a consolidation chamber in which the soot preform is vitrified to form a consolidated preform, the consolidation chamber being longitudinally aligned with the deposition chamber. The deposition chamber preferably comprises axially spaced burners oriented to apply soot in a direction substantially perpendicular to a longitudinal axis of the core cane. The burners are preferably offset at different distances from the longitudinal centerline of the core cane. This helps to get the proper deposition rates as the preform grows in size. One or more environmental seals are positioned between respective chambers of the apparatus to minimize gas and/or contaminant flow into or between the chambers. The seals may include purge gasses or vacuum supplied thereto. The seals may optionally be supplied with purge gasses to heat or cool respective areas of the preform during its manufacture.

In accordance with another embodiment, an optical fiber manufacturing apparatus is provided comprising a downfeed apparatus grasping a continuous supply of core cane and imparting translation and rotational motion to the core cane, a walled deposition chamber, including at least one burner, in which soot is deposited onto the core to form a soot preform, at least one chamber longitudinally aligned with the deposition chamber in which the soot preform is vitrified and melted to form a tapered end, and a drawing mechanism to draw an optical fiber from the tapered end.

In accordance with another embodiment, an optical fiber manufacturing apparatus is provided comprising a longitudinally traversing supply of continuous core cane, and a deposition stage including a plurality of burners positioned at different radial distances from a longitudinal axis of the cane to apply soot at longitudinal intervals thereby forming a soot preform.

Advantageously, the method and apparatus in accordance with the invention may produce continuous lengths of preforms and high quality optical fiber having low attenuation. In addition, the incidence of inprocess fiber breaks and defects are reduced as compared to prior art continuous methods.

Other aspects and advantages of the invention will be understood with reference to the following detailed description, claims and appended drawings.

### BRIEF DESCRIPTION OF THE FIGURES

FIG. 1 the continuous optical fiber manufacturing apparatus in accordance with the invention.

FIG. 2 illustrates a downfeed of the continuous optical fiber manufacturing apparatus.

FIG. 3 illustrates a partial side view of the positioning of the burners in accordance with the invention.

FIG. 4 illustrates a cross-sectional side view of seal in accordance with the invention.

FIG. 5 illustrates a side view of an alternate burner configuration in accordance with the invention.

### DETAILED DESCRIPTION OF THE INVENTION

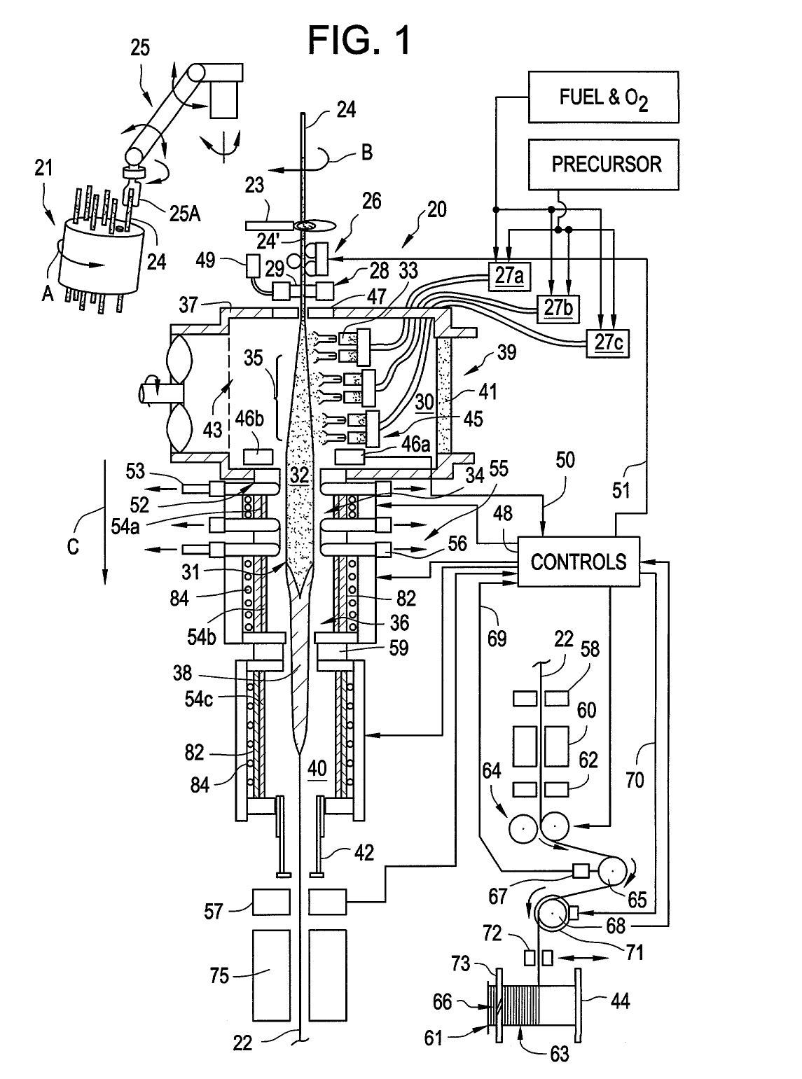

Reference will now be made in detail to the present preferred embodiment of the invention with reference to the drawings. Wherever possible, the same reference numerals shall be use throughout to refer to the same or like parts. According to the invention, as illustrated in FIG. 1, a core cane storage module 21 holds a plurality of core cane segments 24 ready to provide a continuous supply of core cane segments of a predetermined length. The core canes 24 include a core portion, preferably formed of doped silica, and preferably a thin nearclad portion, preferably of a pure silica. The core segments 24 are comprised of fully consolidated glass and drawn to a predetermined diameter (approximately 9-11 mm) in a previous step and each core cane is formed to include the desired index of refraction profile of the fiber ultimately desired. The module 21 may be rotatable as indicated by arrow A. Each cane segment 24 is, in turn, transferred from the module 21 to the top of the apparatus 20 where they are butt welded to the end of the next adjacent core cane segment 24′ by aligning and heating the but sections of each adjacent cane and thereby providing a continuous supply of core cane. The transfer may be accomplished manually or via an articulating robot 25. Moreover filling of the module 21 may be accomplished manually or automatically.

In the case of a robot 25 being employed, a gripper 25A grasps the core cane 24, withdraws the cane from the module 21, and transfers the cane 24 to the apparatus 20 where it is aligned with, and welded to, the previously supplied core cane 24′. The robot 25 may provide suitable rotation such that the cane 24 is spun at the same rate as the cane 24′ during welding. Radial alignment is preferably accomplished by chucks or other gripping mechanisms having common longitudinal centerlines.

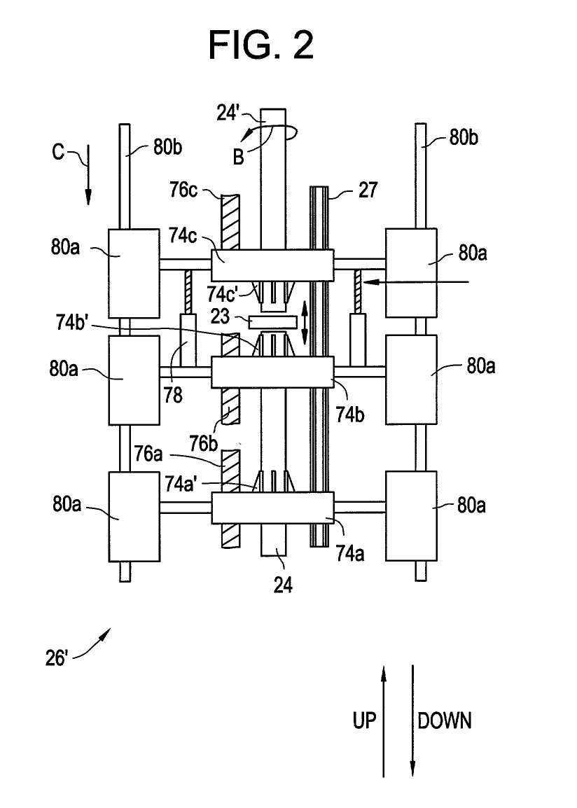

In one preferred embodiment, welding is accomplished by utilizing the down feed apparatus 26′ shown in FIG. 2. The apparatus grasps the exterior surface of the core cane 24 supplied by the robot 25 (FIG. 1) and brings the core cane 24 into axial alignment and abutting relationship with the previously supplied core cane 24′. Simultaneously, both core canes 24, 24′ are rotated at the same speed by the downfeed 26. Gripping members 74a′-c′ of chucks 74a, 74b grasp the first core cane 24 while chuck 74c grasps the second core cane 24′. A common splined gear drive spins the core canes 24, 24′ and gripping members 74a′-c′ relative to their respective chuck casings. Because the chucks 74a-c are geared to a common drive, the respective gripping members 74a′-c′ of each rotate at precisely the same speed. Although, a splined drive member is shown, it should be understood that any type of drive mechanism which synchronizes the motion of the chuck's gripping members 74a′-c′ may be employed.

Drive members 76a-c, such as the ball screws shown, move the position of the canes 24, 24′ relative to one another and, once in contact, in a constant downward motion. As the interface of the canes 24, 24′ is positioned in the proximity of the burner 23, sufficient heat is applied by burner 23 to fuse the core canes together. Because of the constant downward motion of the canes, the burner 23 is preferably mobile also; traversing at the downfeed rate along with the interface as the canes move downward and then shuttling back to a starting point to await the next weld. Slide assemblies 80a interconnected to the chucks 74a-c slide along rails 80b to allow independent longitudinal movement of the chucks while restraining other movements. It should be recognized that during the cane welding operation, the entire assembly, including the core canes, are preferably rotated and traversed downwardly by downfeed 26 as indicated by arrows “B” and “C”, respectively. From the forgoing, it should be apparent that downfeed 26 continuously feeds the fused cane into the deposition chamber 30 of the continuous fiber making apparatus 20 while at the same time rotating the canes at the desired speed.

This continuous downfeed is accomplished by simultaneously gripping and releasing the respective chucks to achieve a downfeed rate of about 25 m/s. Having multiple drives 76a-c allows at least one of the chucks to be moved in an axial direction (upward and downward) independently of the others to accomplish the constant downfeed motion. For example, once the weld has been accomplished, chuck 74b may continue to be traversed axially downward at the desired rate, while grip of chuck 74a is released and traversed upward to a starting position where the cane is re-grasped. The chuck 74a now moves downward while the chuck 74b moves upward to its starting position. Chuck 74b then re-grips the cane thereby allowing the chuck 74a to loosen its grip and again move upwardly. Thus, this process is repeated over and over to accomplish the desired downfeed action. Chuck 74c may move in synchronism with either one of the chucks 74a, 74b. The chucks movements are preferably accomplished by a suitable control system 48 to control the weld operation and the downfeed rate. Optionally, wheels, belts, hand-over-hand, or other gripping devices may be employed to provide the desired downfeed rate. In general, any device that functions to cause simultaneous downfeed and rotation of the canes may be employed.

According to a preferred embodiment, the weld is preferably .formed by a burner 23, such as a methane and oxygen ring burner surrounding the interface between the canes. One or more sensor(s) 78 may be employed to detect the parameters indicative of weld formation, such as the distance between the canes, or the force applied to the weld. Although a ring burner is illustrated, it should be recognized that any suitable alternative means for welding or fusing the cane interfaces may be employed just as long as the method provides sufficient heat to fuse together the canes. Alternate methods include laser methods, multiple point source burners, induction heaters, fusion welding or any burner arrangement surrounding the canes. The core and cladding portions of the canes are preferably precisely aligned and welded to provide a weld of optical quality. Precisely aligning the chucks is one means for achieving this.

Once the weld is completed, the traversing portion of the core cane 24′ is cleaned by a cleaning device 28. The cleaning device is sufficiently spaced from the weld forming area of the apparatus such that the cane is cooled sufficiently prior to cleaning. Optional cooling gas flow may be employed for this purpose also. Preferably, the cleaning is accomplished by an absorbent wiper 29, saturated with solvent that comes into physical contact with and cleans the cane 24′ through a combination of chemical action and mechanical scrubbing. The preferable solvent is a alcohol containing, such as a mixture of alcohol and water and is supplied from a container 49. The wiper element 29 is continuously replaced by introducing a new wiper surface into contact with the cane 24′ such that any debris/contamination is removed. This may be accomplished by one or more rolls of wiper material, which are continuously unwound from one roll and rewound on a takeup roll, for example. Cleaning ensures that the core entering the deposition chamber is free from surface contaminants (e.g., dust from handling or debris from the welding step) which may cause surface defects. These surface defects, although small in comparison to the size of the cane, may case seeds to form. These seeds may form break sites as the preform is drawn into fiber.

The cane 24′ and the integral preform sub-assembly 31 are traversed along the axial longitudinal direction, as indicated by arrow “C”, by the downfeed mechanism 26 grasping the cane. In one embodiment, the entire preform assembly 31 made up of soot preform 32, consolidated portion 38, and canes 24, 24′ is rotated while being traversed longitudinally. The consolidated preform assembly 31 is rotated about the longitudinal axis at about 30-250 rpm.

The soot portion 32 of the preform is formed by traversing the cane 24′, by the action of feed mechanism 26, into the deposition chamber 30. Within this chamber 30, a preferably vaporized precursor (such as a SiCl₄ or octamethicyclotetrasiloxane or other siloxane including precursors) is introduced into flames produced by a plurality of burners 33 to oxidate the precursor and deposit fine particulate glass soot silica (such as SiO₂) onto the outer surface of the cane 24′. The burners continue to deposit soot layer after layer until the desired dimensions are achieved. Preferably, the flames of burners 33 are produced by igniting a methane fuel.

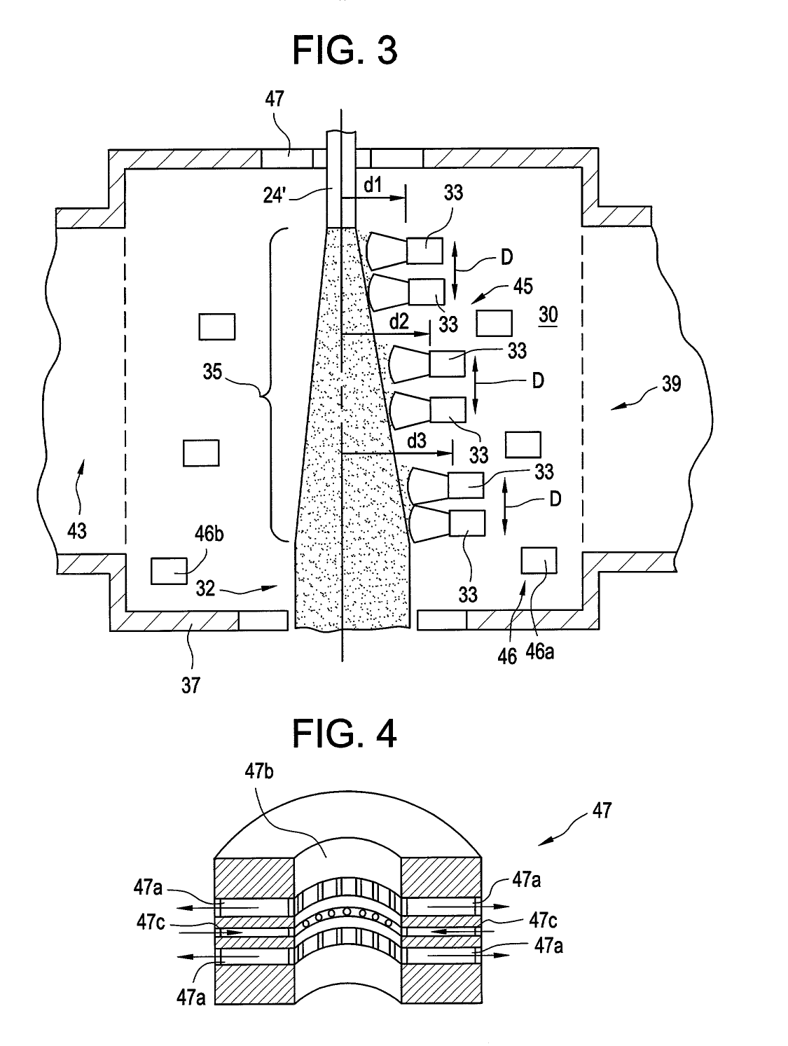

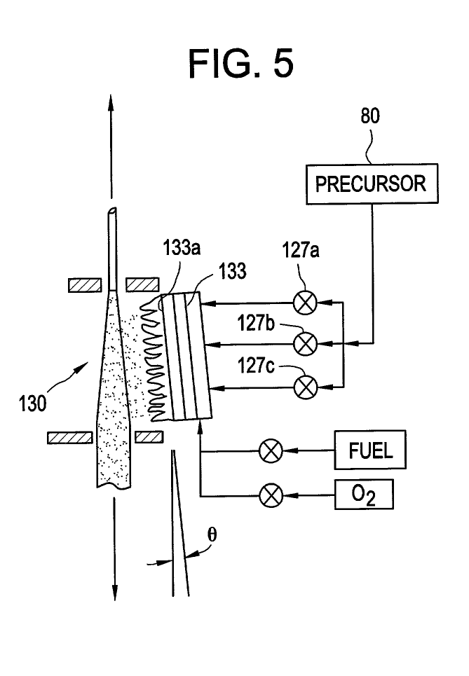

Referring to FIGS. 1 and 3, the deposition stage occurring within the deposition chamber 30 includes a plurality of burners 33 staged at various intervals along the longitudinal length of the portion 35 of the soot preform 32 being formed. The burner array 45 includes at least three, and more preferably six or more burners 33. The respective burners 33 are spaced radially outward from the centerline of the core cane 24′ at different distances d1, d2, d3. As the forming portion 35 grows in diameter, the burners 33 remain spaced at an approximately optimum distance from the deposition surface thereby increasing deposition rate. The burners 33 may be mounted stationary or they may traverse longitudinally up and down, thus jogging slightly along arrows “D” to provide more uniform soot deposition. Although individual burners are illustrated, strip or planar burners may be employed wherein the strip is positioned such that the burner face is non-parallel to the core cane axis by an angle θ, which is greater than zero. Most preferably, the burner strip 133 is oriented such that its face 133a is located approximately equidistant from the preform's surface within the deposition chamber 130 as illustrated in FIG. 5. The precursor 80 flow to the various parts of the burner 133 may be suitably adjusted by valves 127a-c. Moreover, flows of fuel and combustion supporting oxygen are also controlled by valves. More details of such burners are described in WO 99/32410filed Dec. 3, 1998 entitled “Burner And Method For Producing Metal Oxide Soot.”

An enclosure shroud 37 preferably surrounds the burners 33 and the forming portion 35. Shroud 37 includes an inlet 39 having a porous filter 41 and an outlet 43. The shroud and filter function to minimize contamination within the deposition chamber 30 from the surrounding atmosphere and adjacent processes. Preferably, inlet 39 and outlet 43 are approximately the same size as the burner array 45. This provides for substantially uniform and laminar flow across the forming portion 35 which is desirable to provide good soot deposition rates.

A first environmental seal 47 is included at a first end of the deposition chamber 30 where the cane 24′ is introduced thereinto. This seal 47 is preferably a seal with a close fit diameter, which prevents any appreciable entry of air or contaminants into the chamber 30. Preferably, the pressure in the chamber 30 is such that any leakage flow is outward towards the surrounding atmosphere through any seal gap present. In a preferred embodiment shown in FIG. 4 the seal may include a vacuum channel(s) 47a which evacuate the central opening 47b of the seal and prevents any particulates or other contaminants from entering into the deposition chamber 30 through the seal. Moreover, the evacuation preferably helps reduce adherence of contaminants to the cane. Optionally, the seal 47 may include a purge gas supplied through passage(s) 47c. Purge gas may be an inert gas such as helium, nitrogen or CO₂ and may optionally be preheated to heat the cane 24′ to a desired temperature as it passes through the seal 47 and into the deposition chamber 30. Moreover, the purge gas may be provided to minimize lateral deflections of the preform. By incorporating flows that radially surround the preform at the various seal points, purge gasses may be introduced to center the preform along its length and minimize any radial vibrations.

A diameter measurer, such as a non-contact laser sensor, is preferably located at a second end of the chamber 30 and is used to measure the final diameter of the soot preform 32. The sensor includes a transmitter 46a and a receiver 46b, both of which are preferably housed within the chamber 30. The soot preform diameter is fed back to appropriate controls 48 through line 50 to control the longitudinal feed rate via line 51 of feed mechanism 26 thereby ensuring that the diameter is kept within predetermined bounds or limits preprogrammed into the controls. In another embodiment, the apparatus may also include, as shown in FIG. 3, an intermediate sensor or sensors (e.g., 46 c-d, 46 e-f) which provide information regarding the diameter of the preform at intermediate points along the longitudinal length of the forming section 35 of the soot preform 32. The flow of precursor material, down feed rate, and other burner conditions may be adjusted independently at the various burners 33 based upon such feedback information so that the desired end diameter (at the point of entry into the next chamber) of the preform 32 is achieved. For example, the amount of precursor provided to each burner 33 may be adjusted by independently adjusting flow through distributors 27a-c. For clarity, supplies of precursor are not shown. However, it should be understood that distributors 27a-c are supplied with a source of liquid or vaporized precursor such as SiCl₄, GeCl₄ or combinations thereof.

In a next preferred step in the process, the preform 32, now at its intended final diameter, passes through a drying chamber 34 positioned in axial alignment with the deposition chamber 30. Within the drying chamber 34, a drying gas mixture, e.g., of about 96%-99.8% helium and 0.2%-4% chlorine gas, dries the preform 32 and removes unwanted water therefrom. Certain undesirable metals may also be removed. The temperature of the dehydration chamber is preferably between about 900° C. and 1200° C. The feed rate is such that the dwell time within the chamber 34 for any portion of the preform 32 passing therethrough is sufficient to adequately remove a desired amount of unwanted water from the preform and raise it to the appropriate temperature.

The chamber 34 is preferably closed to the outside atmosphere. To minimize flow of process gasses to and from the chamber, a second seal 52 is preferably positioned between the deposition chamber 30 and the drying chamber 34. The seal 52 is preferably a labyrinth-type seal and may include one or more ports 53 for applying a vacuum or purge gas or exhausting any gasses passing alongside the preform 32 in the area of the seal. The seal 52 is preferably made to fit as close with the diameter of the preform as practicable. Generally, because of the temperature and pressures, flow is predominantly from the drying chamber 34 to the deposition chamber 30. Thus, it is desirable to exhaust a portion of the gas introduced into the drying chamber 34 through seal port 53 in an effort to minimize contamination of the deposition chamber 30 with chlorine gas. The seal 52 may be of the type described with reference to FIG. 4. It should be understood that the dehydration step may be optional for certain fibers where the fiber drawn from the preform is not operated near the water peak (approx. 1380 nm). Thus, chamber 34 may be removed in its entirety for certain applications.

Following the dehydration step, the preform 32 passes through a consolidation chamber 36 where the soot preform 32 is consolidated into a vitrified glass preform 38. The consolidation chamber 36 is preferably longitudinally aligned with the drying chamber 34 and is also closed to the outside atmosphere. The chamber is preferably heated to between about 1400° C. and 1600° C. and includes an injected atmosphere of helium gas. Alternatively, other inert gasses may be employed also, such as argon. The consolidation chamber 36 is longer than the drying chamber such that a suitable dwell time in the chamber is achieved to consolidate the soot into vitrified glass. The chamber 36 may include variations in temperature along its length. For example, there may be a zone that is of higher temperature than the rest. A third seal 55 is positioned between the drying chamber 34 and the consolidation chamber 36 and minimizes flow of gasses and heat therebetween. In particular, since the temperature differential between the chambers 34, 36 is substantial, a port 56 or ports are utilized to minimize heat transferred from the consolidation 36 to the drying chamber 34 and to minimize chlorine gas migration from the drying chamber 34 to the consolidation chamber 36. Again, the seal 55 may be of the type described with reference to FIG. 4. Heat transfer may be minimized by the addition of cooling purge gasses. A vacuum may be applied to evacuate chlorine or other drying gasses. It should be recognized that the drying and consolidation steps may take place in one common chamber.

Upon being consolidated, the preform 38 is passed into draw chamber 40, which is longitudinally aligned with the consolidation chamber 36. The draw chamber is also preferably closed to the outside environment and includes a controlled atmosphere. A fourth seal 59 functions to seal between the consolidation 36 and draw 40 chambers and prevent heat transfer between the chambers. Since the process gasses employed in the consolidation and draw chambers are essentially the same, the primary purpose of seal 59 is to prevent heat from transferring from the draw 40 to the consolidation chamber 36. The seal 59 may be of the type described in FIG. 4 and may include coolant purge gasses supplied thereto. The draw chamber 40 is preferably set to a temperature of between about 1900° C. and 2200° C. and includes an inert gas atmosphere, such as a helium atmosphere. Within the draw chamber 40, the glass preform melts to the point where a glass gob drops from it. The gob passes through an extension section 42 (which may be, for example, 0.5 m to 4 m long) which serves the function of cooling the fiber symmetrically to a temperature sufficient to reduce the formation of bow in the fiber. It should be recognized that the consolidation and draw chambers may be combined into one common chamber wherein both processes take place simultaneously in one chamber. In this case, there would be significant variations in the temperature profile within the chamber to allow sintering first and then draw at the temperatures mentioned above. Notably, this arrangement may simplify the system considerably.

It should be understood that each of the drying, consolidation, and draw chambers includes a muffle tube 54 that preferably includes a suitable high temperature tolerant lining material. For example, the muffle of the muffle 54a, 54b of the drying 34 and consolidation 36 chambers are preferably a glass material, such as a high-purity fused silica. The draw muffle 54c is preferably a graphite or carbon material, which may include a silicon carbide coating, or other like high temperature tolerant material. Each of the chambers includes a suitable insulation material surrounding them such as carbon felt. Moreover, each of the chambers includes a heat source 84 in communication therewith, such as an induction heater or the like for supplying the required process heat.

Once the gob drops and the apparatus is threaded, the fiber 22 passes through the non-contact diameter sensor 57; such signal being provided to the controls 48 to control the draw tension in the fiber 22. The fiber passes through one or more cooling sections 75 where it is rapidly cooled. The fiber 22 then passes through one or more coaters 58 where one or more UV coatings are applied. The coatings may include several layers of a urethane acrylate material, which may be of differential stiffness and/or composition. One or more UV irradiators 60 cure the coatings applied. Another diameter measurement 62 is utilized to measure the final coated diameter, as is conventional in the art.

The coated fiber is then grasped by a tension imparting draw assembly 64 including several gripping wheels 64a, 64b which grasp and apply tension to the fiber 22 to draw it from the melting preform 38 at the desired rate. The draw speed of the draw tension assembly 64 is determined by the controls 48 and is dependent, at least in part, upon the diameter measurements taken at the measurer 57 wherein suitable controls maintain (within predetermined limits) the diameter at a set diameter of approximately 125 microns.

Next, the fiber 22 passes about a pulley wheel 65 being mounted to a tension measuring device 67 such as a load cell. A tension applying wheel 68 driven by a motor 71 whose speed is controlled according to controls 48 applies a predetermined tension to the section of fiber 22 wound between the draw tension assembly 64 and the tension wheel 68. This known tension (say, for example about 100 psi) is controllable to the predetermined amount by load cell 67 feeding load information in line 69 to controls 48 and then feeding back a signal to motor 71 in line 70. This tension testing section applies a known tension to the fiber 22 for screening purposes. The screened fiber 22 is then fed through a reciprocating flying head 72 and wound onto spool 44. Preferably, lead meter 61 and main barrel 63 portions are wound sequentially by passing the fiber 22 through a slot 66 formed in the spool flange 72.

It will be apparent to those of ordinary skill in the art that various modifications and variations can be made to the present invention without departing from the scope of the invention. Thus, it is intended that the present invention cover the modifications and variations provided they come within the scope of the appended claims and their equivalents.

What is claimed is:

1. A method of manufacturing optical fiber preform comprising the steps of:
forming a continuous supply of core cane,
grasping and imparting rotational motion to the core cane with a feed apparatus, and
depositing soot onto the core in a deposition chamber to form a soot preform.

2. The method of claim 1 further comprising a step of consolidating the soot preform in a consolidation chamber longitudinally aligned with the deposition chamber thereby vitrifying the soot preform into a consolidated preform.

3. The method of claim 1 further comprising a step of dehydrating the soot preform in a drying chamber longitudinally aligned with the deposition chamber prior to the step of consolidating.

4. The method of claim 1 further comprising a step of forming the preform to be of substantially constant diameter.

5. The method of claim 1 further comprising a step of cleaning a periphery of the core prior to depositing.

6. The method of claim 4 wherein the step of cleaning further comprises passing the core through an apparatus that imparts a wiping action.

7. The method of claim 1 wherein the step of depositing soot is accomplished by using a plurality of longitudinally spaced burners.

8. The method of claim 1 wherein the step of depositing soot is accomplished by burners positioned at points along the longitudinal axis of the core cane.

9. The method of claim 1 wherein the step of forming a continuous supply of core cane comprises welding together a plurality of core cane segments.

10. The method of claim 1 wherein the step of depositing soot is accomplished by at least two spaced burners positioned non-equidistant from a longitudinal axis of the core cane.

11. The method of claim 10 wherein the spaced burners are oriented to apply soot in a direction substantially perpendicular to the longitudinal axis of the core cane.

12. The method of claim 1 wherein during the step of depositing soot, soot is applied in amounts that increase linearly along the longitudinal axis of the core cane within the deposition chamber.

13. An optical fiber preform manufacturing apparatus, comprising:
a downfeeder providing a continuous supply of core cane, the downfeeder grasping and imparting movement to the core cane, and
a deposition chamber, including at least one burner, in which soot is deposited onto the core cane to form an optical fiber soot preform.

14. The apparatus of claim 13 further comprising:
a drying chamber in which the soot preform is dried, the drying chamber being longitudinally aligned with the deposition chamber.

15. The apparatus of claim 13 further comprising a consolidation chamber in which the soot preform is vitrified to form a consolidated preform, the consolidation chamber being longitudinally aligned with the deposition chamber.

16. The apparatus of claim 13 further comprising a cleaner operative to clean a periphery of the core cane.

17. The apparatus of claim 13 further comprising a first diameter measurer to measure a diameter of the soot preform.

18. The apparatus of claim 17 further comprising a second diameter measurer to measure a diameter of the soot preform at a different position than that the fist diameter measurer.

19. The apparatus of claim 13 further comprising spaced burners oriented to apply soot in a direction substantially perpendicular to a longitudinal axis of the core cane.

20. The apparatus of claim 13 further comprising at least one environmental seal positioned between respective chambers.

21. An optical fiber manufacturing apparatus, comprising:
a downfeed apparatus grasping a continuous supply of core cane and imparting translational and rotational motion to the core cane,
a walled deposition chamber, including at least one burner, in which soot is deposited onto the core cane to form a soot preform,
at least one chamber longitudinally aligned with the deposition chamber in which the soot preform is vitrified and melted to form a tapered end, and
a drawing mechanism to draw an optical fiber from the tapered end.

22. An optical fiber manufacturing apparatus, comprising:
a deposition chamber in which soot is deposited onto a core cane to form a soot preform portion,
a consolidation chamber in which the soot preform portion is vitrified to form a consolidated preform portion, and
a draw chamber melting the consolidated preform portion such that an optical fiber may be drawn therefrom, wherein each chamber is longitudinally aligned with an adjacent one of the chambers and at least one environmental seal is positioned between each of the chambers to minimize gas flow between respective adjacent chambers.

23. An optical fiber manufacturing apparatus, comprising:
a longitudinally traversing supply of continuous core cane, and
a deposition stage, including a plurality of burners positioned at different distances from a longitudinal axis of the core cane, to apply soot at longitudinal intervals thereby forming a soot preform.
